(19) United States
(12) Patent Application Publication
(10) Pub. No.: US 2008/0088782 A1
(43) Pub. Date: Apr. 17, 2008

(54) PROCESS OF PRINTING ALIGNMENT LAYER OF LIQUID CRYSTAL DISPLAY

(75) Inventors: Jin-Soo Jung, Goyang-si (KR); Baek-Kyun Jeon, Yongin-si (KR)

Correspondence Address: H.C. PARK & ASSOCIATES, PLC, 8500 LEESBURG PIKE, SUITE 7500, VIENNA, VA, 22182, US

(73) Assignee: Samsung Electronics Co., Ltd., Suwon-si (KR)

(21) Appl. No.: 11/870,709

(22) Filed: Oct. 11, 2007

(30) Foreign Application Priority Data
Oct. 12, 2006 (KR) 10-2006-0099526

(51) Int. Cl. G02F 1/1337

(52) U.S. Cl. 349/124

(57) ABSTRACT

A process of printing an alignment layer of a liquid crystal display is disclosed. The process of printing an alignment layer of a liquid crystal display includes disposing a substrate on a stage, aligning an inkjet head on the upper surface of the substrate, and printing alignment liquid ejected from the plurality of nozzles on the upper surface of the substrate. During the printing of alignment liquid, the stage or inkjet head is reciprocated in a first direction and the inkjet head is reciprocated in the second direction. The inkjet head includes a plurality of nozzles from which alignment liquid is ejected.

### CROSS REFERENCE TO RELATED APPLICATION

This application claims priority from and the benefit of Korean Patent Application No. 10-2006-0099526, filed on Oct. 12, 2006, which is hereby incorporated by reference for all purposes as if fully set forth herein.

### BACKGROUND OF THE INVENTION

1. Field of the Invention

The present invention relates to a process of printing an alignment layer of a liquid crystal display, and more particularly, to a process of printing an alignment layer of a liquid crystal display that may prevent the occurrence of linear stains.

2. Discussion of the Background

Recently, liquid crystal displays (LCD) have been in the spotlight as displaying means. Liquid crystal displays display images using the electrical and optical characteristics of liquid crystal molecules that are injected into a liquid crystal panel. Liquid crystal displays are advantageous because they are small in size, light-weight, and have low power consumption. For these reasons, the liquid crystal display has been widely used in various fields, including as a monitor for a computer and mobile communicator.

The liquid crystal display may be manufactured by a plurality of processes. Generally, a method of manufacturing of a liquid crystal display may include a thin film transistor (TFT) substrate process, a common electrode substrate process, a liquid crystal cell process of bonding a thin film transistor substrate with a common electrode substrate and injecting liquid crystal molecules into a gap there between to manufacture a liquid crystal panel, and a module process of combining the liquid crystal panel manufactured in the liquid crystal cell process with other modules so as to completely manufacture a liquid crystal display.

Further, the liquid crystal cell process may include sub-processes, such as a process of printing an alignment layer, a rubbing process, a process of applying spacers, a process of bonding and cutting the substrate, a process of injecting and sealing liquid crystal molecules, and a process of attaching a polarizer.

Here, the process of printing an alignment layer may be performed on pixel and common electrodes of a thin film transistor substrate and a common electrode substrate that are completely formed. In this case, the alignment layer may be made of high molecular weight polymer. An apparatus for forming an alignment layer is needed to form an alignment layer having a constant thickness on the substrate, and an apparatus for printing an alignment layer using an inkjet head has been used in recent years. In this case, the inkjet head may include a plurality of nozzles for ejecting alignment liquid on the substrate. According to the inkjet type apparatus for printing an alignment layer, the inkjet head may be moved at regular intervals above the substrate and repeatedly print alignment liquid, which may improve the uniformity of the alignment layer.

However, in the above-mentioned process of printing an alignment layer, the alignment liquid ejected from the plurality of nozzles may not have a constant thickness due to the movement of the inkjet head. For this reason, the alignment layer may have difference in thickness on the substrate. The difference in thickness of the alignment layer may cause linear stains and defects in the liquid crystal display.

### SUMMARY OF THE INVENTION

The present invention provides a process of printing an alignment layer of a liquid crystal display that may reduce the difference in thickness of an alignment layer and prevent the occurrence of linear stains.

Additional features of the invention will be set forth in the description which follows, and in part will be apparent from the description, or may be learned by practice of the invention.

The present invention discloses a process of printing an alignment layer of a liquid crystal display. The process includes disposing a mother substrate on a stage, aligning an inkjet head on the upper surface of the mother substrate, and printing alignment liquid ejected from the plurality of nozzles on the upper surface of the mother substrate. During the printing of alignment liquid, the stage or inkjet head is reciprocated in a first direction and the inkjet head is reciprocated in a second direction. The inkjet head includes a plurality of nozzles from which alignment liquid is ejected.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart showing a method of manufacturing a liquid crystal display, which includes a process of printing an alignment layer according to an exemplary embodiment of the present invention.

FIG. 2 is a flowchart showing the process of printing an alignment layer according to an exemplary embodiment of the present invention.

FIG. 3 is a schematic perspective view of an alignment layer printing apparatus used in the process of printing an alignment layer shown in FIG. 2.

FIG. 4 is a bottom perspective view of an inkjet head of the alignment layer printing apparatus shown in FIG. 3.

FIG. 5 schematically shows a three-scan process of printing an alignment layer that is an example of the process of printing an alignment layer shown in FIG. 2.

FIG. 6A, FIG. 6B, and FIG. 6C are views showing the process of printing an alignment layer shown in FIG. 5.

FIG. 7 schematically shows a four-scan process of printing an alignment layer that is an example of the process of printing an alignment layer shown in FIG. 2.

FIG. 8A, FIG. 8B, FIG. 8C, and FIG. 8D are views showing the process of printing an alignment layer shown in FIG. 7.

FIG. 9 schematically shows a six-scan process of printing an alignment layer that is an example of the process of printing an alignment layer shown in FIG. 2.

FIG. 10A, FIG. 10B, FIG. 10C, FIG. 10D, FIG. 10E, and FIG. 10F are views showing the process of printing an alignment layer shown in FIG. 9.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as being limited to the exemplary embodiments set forth herein. Rather, these exemplary embodiments are provided so that this disclosure is thorough, and will fully convey the scope of the invention to those skilled in the art. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present.

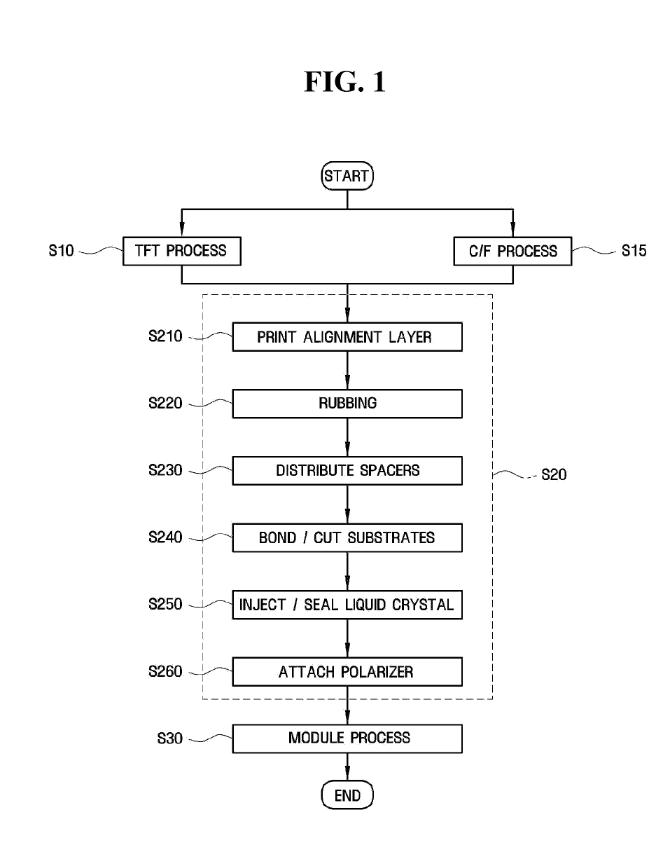

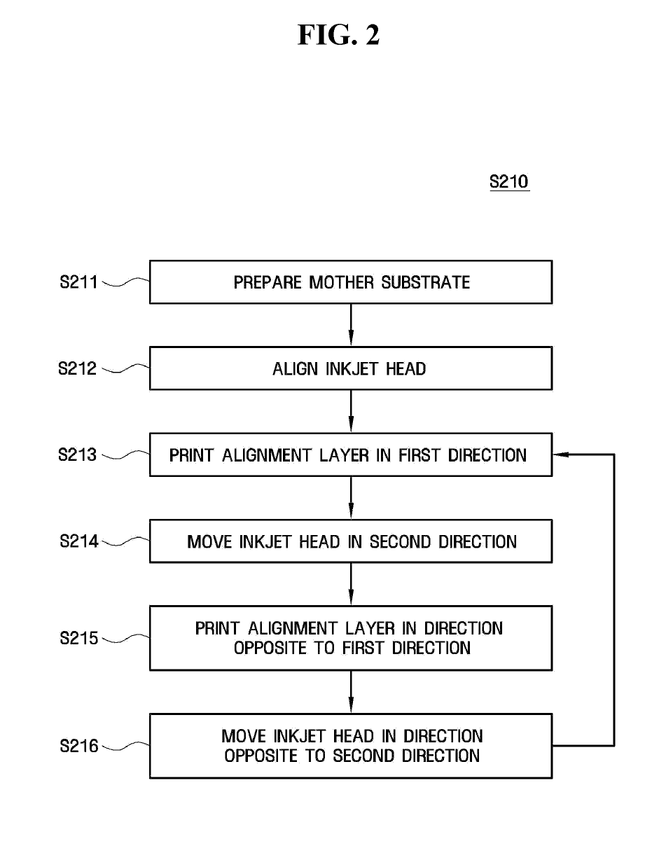

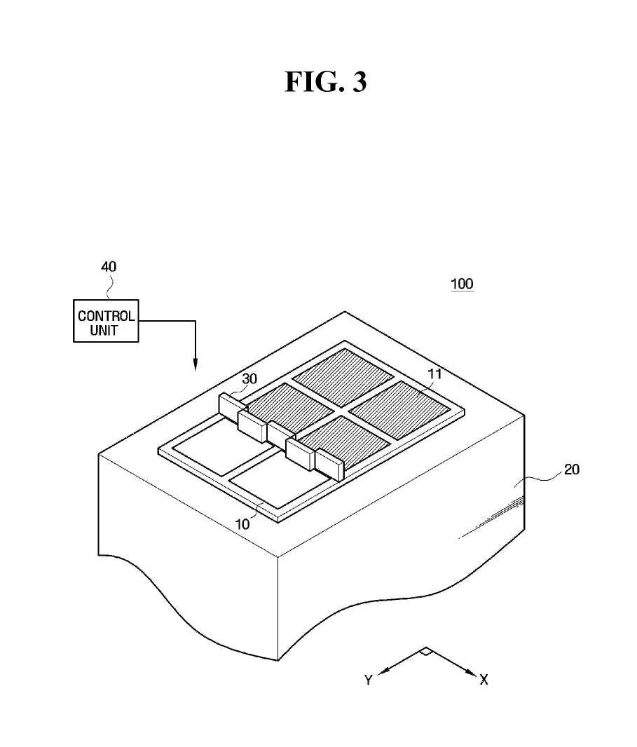

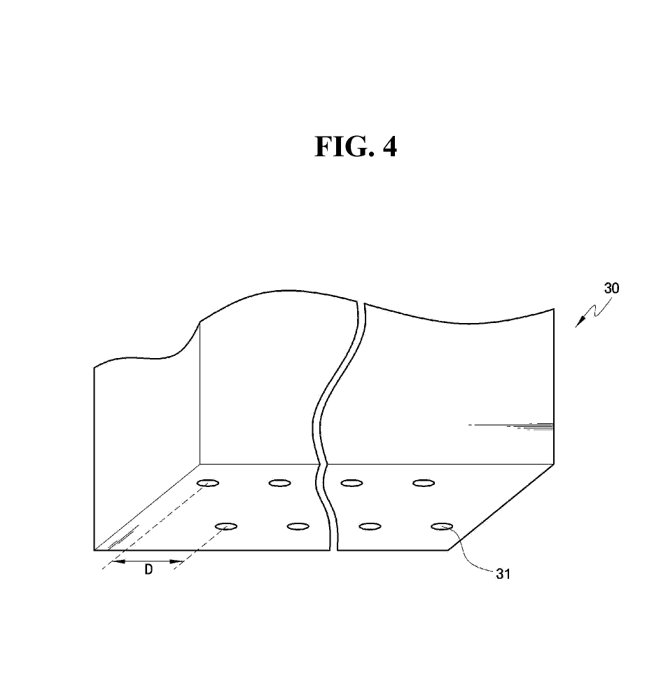

FIG. 1 is a flowchart showing a method of manufacturing a liquid crystal display, which includes a process of printing an alignment layer according to an exemplary embodiment of the present invention, and FIG. 2 is a flowchart showing the process of printing an alignment layer according to the embodiment of the present invention. Further, FIG. 3 is a schematic perspective view of an alignment layer printing apparatus used in the process of printing an alignment layer shown in FIG. 2, and FIG. 4 is a bottom perspective view of an inkjet head of the alignment layer printing apparatus shown in FIG. 3.

First, referring to FIG. 1, a method of manufacturing a liquid crystal display may include a TFT process S10 of manufacturing a thin film transistor mother substrate in which a plurality of thin film transistor substrates are formed, a C/F process S15 of manufacturing a common electrode mother substrate in which a plurality of common electrode substrates are formed, a liquid crystal cell process S20 of bonding the thin film transistor mother substrate manufactured in the TFT process S10 with the common electrode mother substrate manufactured in the C/F process S15 and injecting liquid crystal molecules into a gap there between to manufacture a liquid crystal panel, and a module process S30 in which the liquid crystal panel manufactured in the liquid crystal cell process S20 is combined with other modules so as to complete manufacture of the liquid crystal display.

Each above-mentioned process may include a plurality of sub-processes. For example, the TFT process S10 may include a process of depositing a thin film, a photolithography process, and an etching process, which are included in the method of manufacturing a silicon semiconductor, and test and cleaning processes performed before or after each sub-process.

Further, the liquid crystal cell process S20 may include a plurality of sub-processes. For example, the liquid crystal cell process S20 may include sub-processes, such as a process of printing an alignment layer S210, a rubbing process S220, a process of distributing spacers S230, a process of bonding and cutting substrates S240, a process of injecting and sealing liquid crystal molecules S250, and a process of attaching a polarizer S260.

The process of printing an alignment layer S210 may be performed on pixel and common electrodes of two mother substrates completely formed during the TFT process S10 and the C/F process S15, for example, the thin film transistor mother substrate and the common electrode mother substrate. In this case, the alignment layer may have excellent adhesion to the surface of indium tin oxide (ITO) or indium zinc oxide (IZO), and may be formed in the shape of a thin film having a constant thickness of 1,000 ∪ or less at a temperature of 200° C. or less. Further, the alignment layer may have excellent electrical and chemical stability and may include a high molecular weight polymer material. For example, the alignment layer may be made of polyimide, polyimide-based compound, polyvinyl alcohol, polyamic acid, or the like, but the material of the alignment layer is not limited thereto.

Hereinafter, the process of printing an alignment layer of a liquid crystal display will be described in detail with reference to FIG. 2, FIG. 3, and FIG. 4.

First, referring to FIG. 2, the process of printing an alignment layer S210 according to the present invention may include sub-processes, such as a process of preparing a mother substrate S211, a process of aligning an inkjet head S212, a process of printing a portion of an alignment layer in a first direction S213, a process of moving the inkjet head in a second direction S214, a process of printing a portion of an alignment layer in a direction opposite to the first direction S215, and a process of moving the inkjet head in a direction opposite to the second direction S216. After the process of moving the inkjet head in the direction opposite to the second direction S216, the above-mentioned sub-processes S213, S214, S215, and S216 may be repeatedly performed.

Further, referring to FIG. 3 and FIG. 4, an alignment layer printing apparatus 100 used in the process of printing an alignment layer according to the present invention may include a stage 20, on which a mother substrate 10 is placed and coupled to the stage 20, one or more inkjet heads 30 including a plurality of nozzles 31, and a control unit 40 for controlling the stage 20 and inkjet heads 30.

First, a mother substrate 10 is positioned on and coupled to the stage 20 of the alignment layer printing apparatus 100 (S211). In this case, the mother substrate 10 may be positioned on and coupled to the stage 20 by, for example, vacuum absorption. The mother substrate 10 may include a plurality of thin film transistor substrates and/or common electrode substrates 11 formed in the above-mentioned TFT process S10 and/or C/F process S15.

Subsequently, a plurality of inkjet heads 30 filled with alignment liquid may be aligned above the mother substrate 10, for example, along one side of the mother substrate 10 (S212). In this case, as shown in FIG. 4, each of the inkjet heads 30 may be provided with a plurality of nozzles 31. Specifically, a plurality of nozzles 31 for ejecting the alignment liquid onto the mother substrate 10 may be provided on the lower side of each inkjet head 30. In this case, the pitch of the nozzles 31, that is, the distance D between adjacent nozzles 31, may be in the range of, for example, 730 to 760 μm, preferably, 740 to 750 μm. The plurality of nozzles 31 may be arrayed to have a zigzag shape on the lower side of each inkjet head 30. Further, the inkjet heads 30 partially overlap each other and are arrayed to have a zigzag shape on the upper surface of the mother substrate 10.

Next, while the stage 20 is moved in the first direction of the mother substrate 10, for example, in a Y-direction, an alignment layer is printed on the mother substrate 10 by the plurality of inkjet heads 30 (S213). Specifically, the control unit 40 of the alignment layer printing apparatus 100 supplies predetermined signals, for example, control signals to control piezoelectric parts (not shown) of the plurality of nozzles 31, to the plurality of inkjet heads 30 causing alignment liquid to be ejected from the plurality of nozzles 31. For example, when the control signals supplied from the control unit 40 to the plurality of nozzles 31 correspond to “ON”, the plurality of nozzles 31 eject alignment liquid. Further, when the control signals supplied from the control unit 40 to the plurality of nozzles 31 correspond to “OFF”, the plurality of nozzles 31 do not eject alignment liquid.

When the plurality of inkjet heads 30 is fixed in position, the control unit 40 allows the stage 20 to move in the first direction and the plurality of nozzles 31 to eject alignment liquid onto the upper surface of the mother substrate 10. In this case, the alignment liquid ejected from the plurality of nozzles 31 may be positioned on the upper surface of the mother substrate 10 at regular intervals, for example, at locations spaced from one another at substantially the same interval as the distance D between the nozzles 31. Accordingly, the alignment layer printing apparatus 100 may print rows of alignment liquid extending in the first direction, for example, in the Y-direction, on the mother substrate 10 from one side thereof to the other side thereof at regular intervals.

Subsequently, the plurality of inkjet heads 30 may be moved in the second direction of the mother substrate 10, for example, in an X-direction (S214). Specifically, after an alignment layer is printed in the first direction of the mother substrate 10 (S213), the control unit 40 supplies predetermined signals, for example, signals to move the plurality of inkjet heads 30 in the second direction, to the plurality of inkjet heads 30. In this case, the plurality of inkjet heads 30 may be moved along the other side of the mother substrate 10 in the second direction of the mother substrate 10 in accordance with the above-mentioned signals. The distance in which the plurality of inkjet heads 30 is moved in the second direction may be substantially the same as, for example, half the distance D between the nozzles 31.

Subsequently, while the stage 20 is moved in the direction opposite to the first direction of the mother substrate 10, for example, in a direction opposite to the Y-direction, an alignment layer is printed on the mother substrate 10 by the plurality of inkjet heads 30 (S215). Then, the plurality of inkjet heads 30 may be moved in the second direction by a distance equal to half the distance between the nozzles D in the preceding process. Accordingly, when the plurality of inkjet heads 30 moved in the second direction of the mother substrate 10 is fixed in position, the control unit 40 allows the stage 20 to move in the direction opposite to the first direction. Further, the control unit 40 supplies predetermined signals to the plurality of nozzles 31, causing the plurality of nozzles 31 to eject alignment liquid onto the upper surface of the mother substrate 10. The alignment liquid, which is ejected from the plurality of nozzles 31 onto the upper surface of the mother substrate 10 in process S215, may be ejected between the rows of alignment liquid ejected from the plurality of nozzles 31 in the preceding process, for example, in the process of printing an alignment layer in the first direction of the mother substrate 10 (S213). In this case, the alignment liquid ejected onto the mother substrate 10 in the two processes S213 and S215 may be disposed at regular intervals, for example, at intervals substantially equal to half the distance D between adjacent nozzles 31.

Further, as described above, the control unit 40 may supply control signals to control the piezoelectric parts (not shown) formed in the plurality of nozzles 31 to the plurality of inkjet heads 30 causing alignment liquid to be ejected from the plurality of nozzles 31. Accordingly, the alignment layer printing apparatus 100 may print rows of alignment liquid, extending parallel to the rows of alignment liquid disposed during the first printing, on the mother substrate 10 from one side thereof to the other side thereof.

Subsequently, the plurality of inkjet heads 30 may be moved in the direction opposite to the second direction of the mother substrate 10, for example, in a direction opposite to an X-direction (S216). Specifically, after an alignment layer is printed in the direction opposite the first direction of the mother substrate 10 (S215), the control unit 40 supplies predetermined signals, for example, signals to move the plurality of inkjet heads 30 in the direction opposite to the second direction, to the plurality of inkjet heads 30. The plurality of inkjet heads 30 may be moved along one side of the mother substrate 10 in the direction opposite to the second direction of the mother substrate 10 in accordance with the above-mentioned signals. The distance in which the plurality of inkjet heads 30 is moved in the direction opposite to the second direction may be substantially the same as, for example, a quarter of the distance D between the nozzles 31.

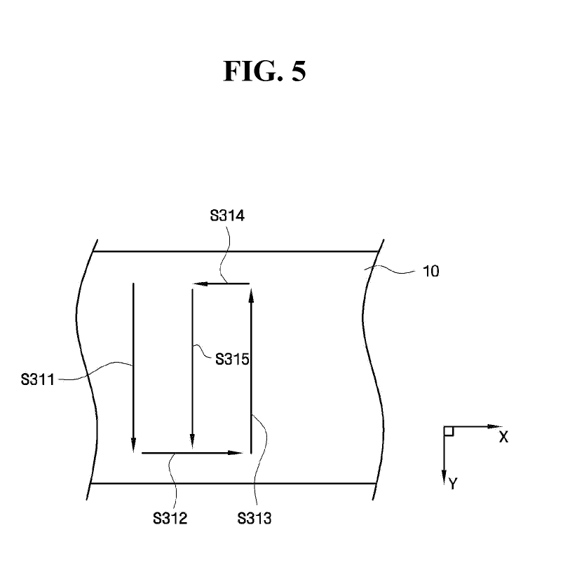

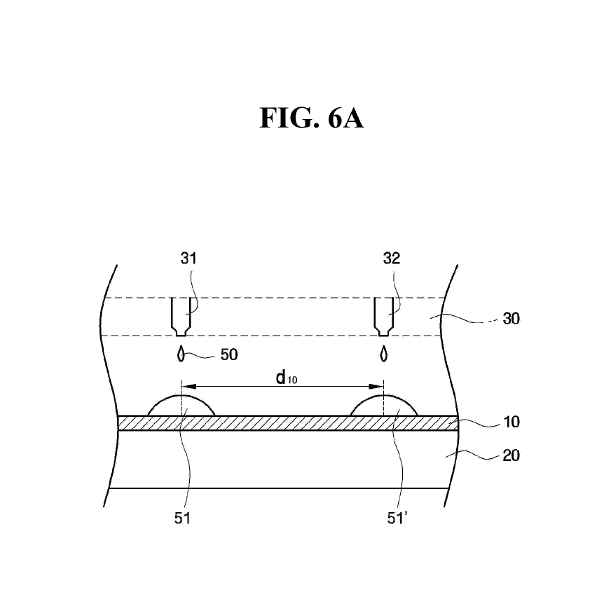

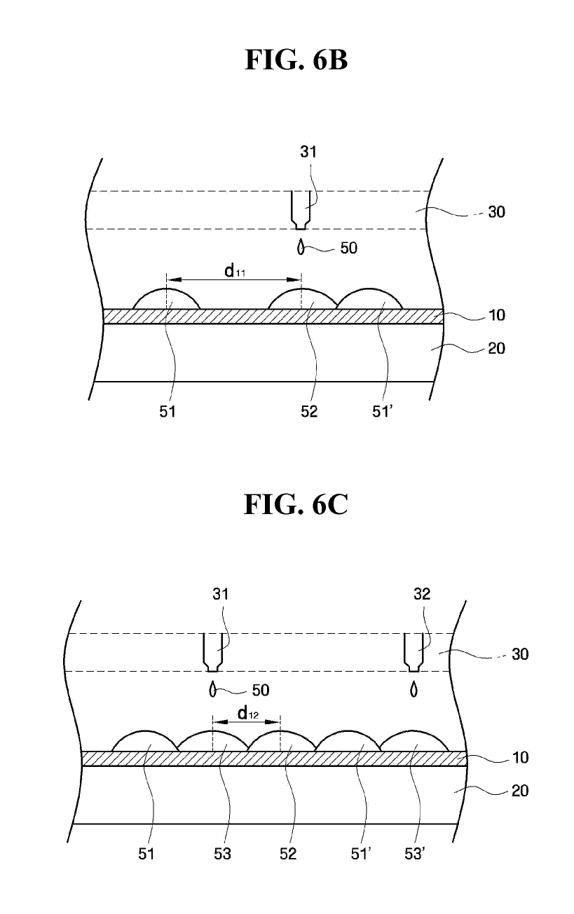

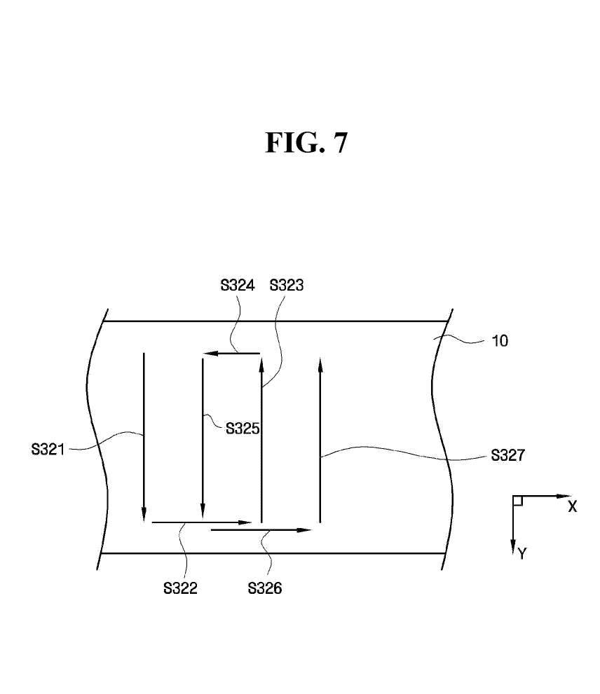

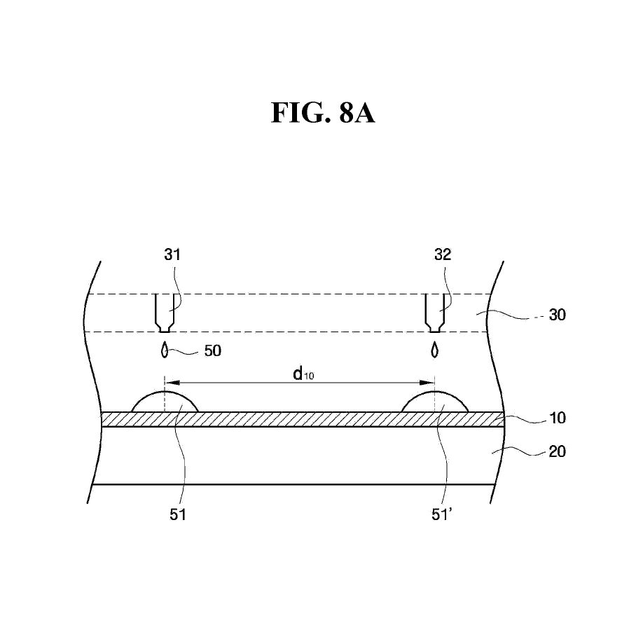

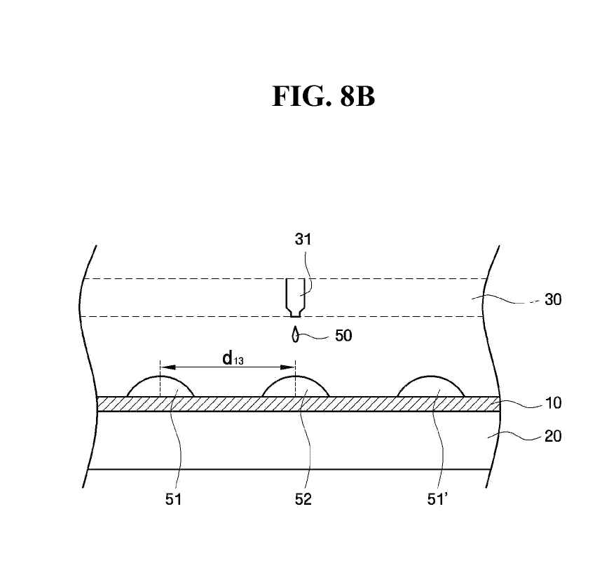

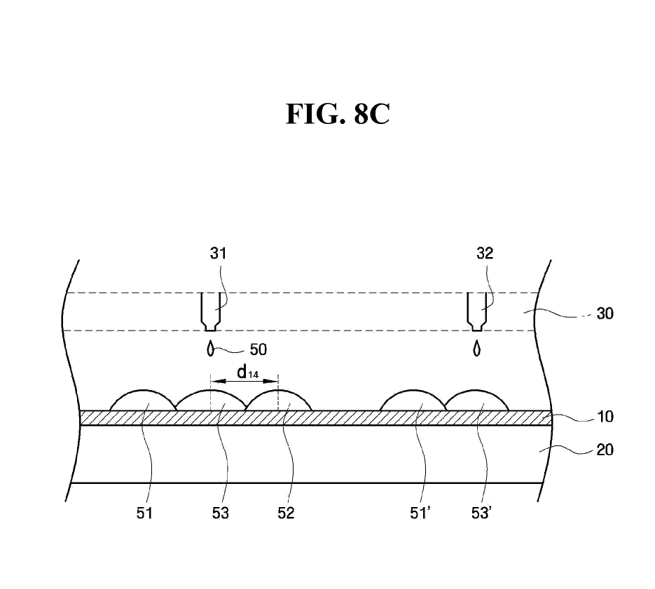

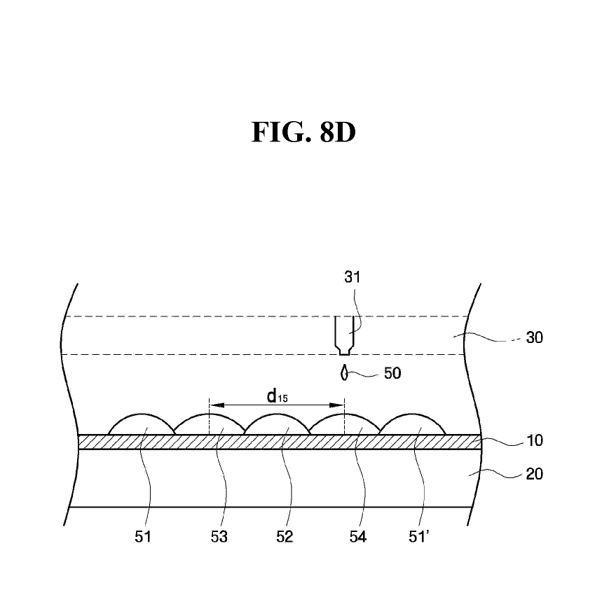

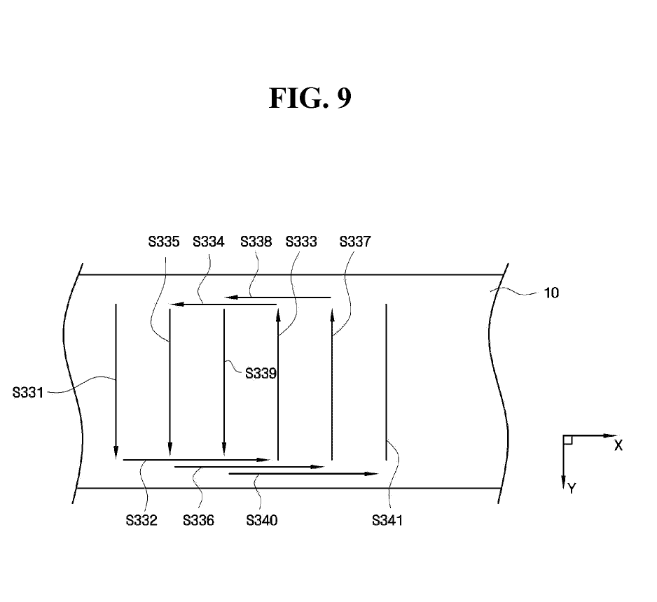

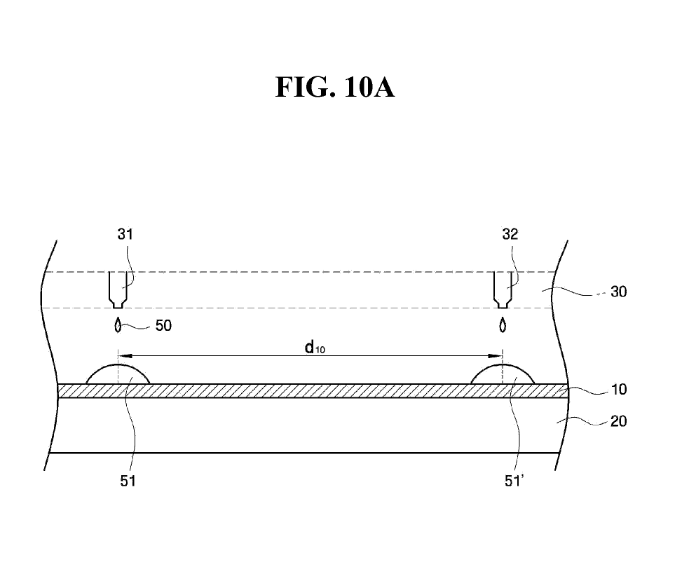

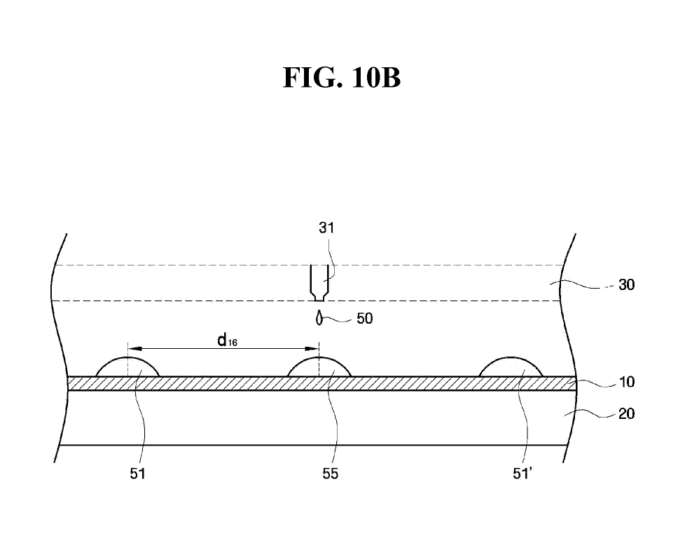

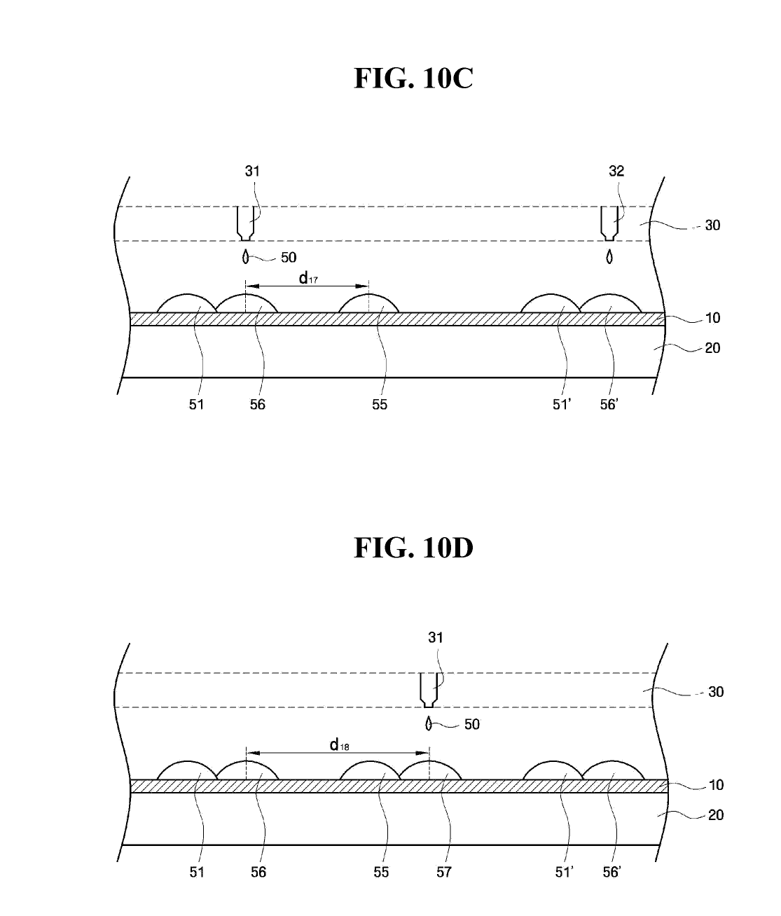

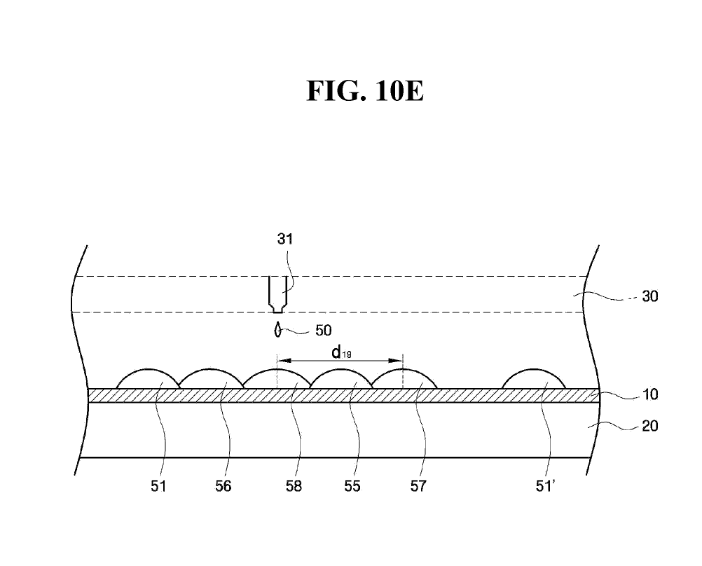

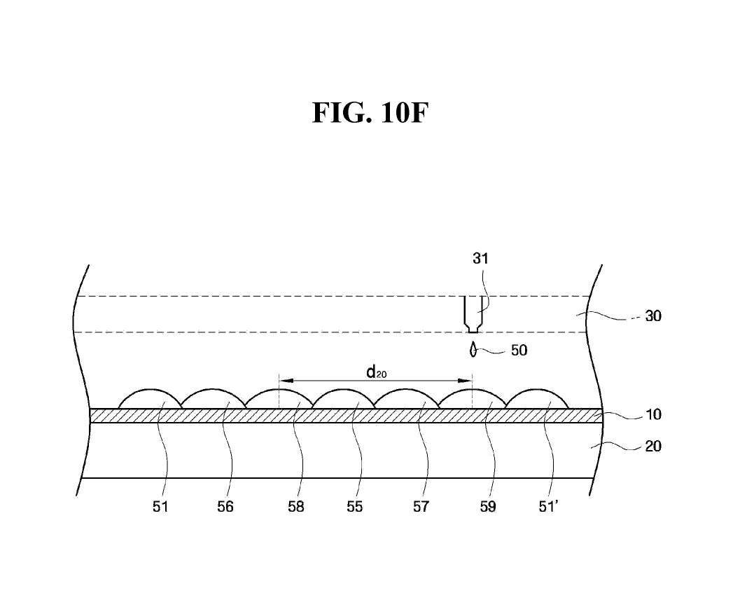

Further, the above-mentioned process, that is, the process of printing the alignment layer in the first direction of the mother substrate 10 (S213), may be repeated after the process of moving the plurality of inkjet heads 30 in the direction opposite to the second direction of the mother substrate 10 (S216). Repetition of this process (S213) may level the alignment layer printed on the mother substrate 10, that is, it may provide for an alignment layer having a constant thickness. A three-scan process of printing an alignment layer, a four-scan process of printing an alignment layer, a six-scan process of printing an alignment layer, or the like may be employed as the process of printing an alignment layer while the inkjet head is reciprocated in the second direction (S210) as described above. These processes will be described below in detail below with reference to FIG. 5, FIG. 6A, FIG. 6B, FIG. 6C, FIG. 7, FIG. 8A, FIG. 8B, FIG. 8C, FIG. 8D, FIG. 9, FIG. 10A, FIG. 10B, FIG. 10C, FIG. 10D, FIG. 10E, and FIG. 10F.

Referring to FIG. 1, after the alignment layer is printed as described above (S210), rubbing may be performed in a predetermined direction (S220). In this case, the rubbing may be performed using a smooth cloth having cotton or nylon-based fibers implanted therein. Accordingly, a plurality of liquid crystal molecules, which may be interposed between two mother substrates in the process of injecting and sealing liquid crystal S250 to be described below, may be aligned on the surface of the alignment layer in a predetermined direction.

Subsequently, spacers may be distributed on the alignment layer on which the rubbing is performed (S230). The spacers maintain a constant gap between the thin film transistor mother substrate and the common electrode mother substrate.

Next, the thin film transistor mother substrate and the common electrode mother substrate are bonded to each other and cut into a predetermined size, for example, a size corresponding to a liquid crystal cell (S240).

In this case, a seal pattern formed of a sealant may be used to bond the two mother substrates to each other. The seal pattern may be formed on the thin film transistor mother substrate and/or common electrode mother substrate in a process of forming a gap into which liquid crystal molecules are injected, which will be described below.

Further, the two mother substrates, which are bonded to each other by the above-mentioned seal pattern, may be cut into a size corresponding to a liquid crystal cell. In this case, a process of cutting the two mother substrates bonded to each other may include, for example, a scribe process of forming cut lines on the surface of a glass with a pen made of diamond and a break process of separating cut assemblies from each other by impact, but it is not limited thereto.

Liquid crystal molecules are injected into a gap between the thin film transistor substrate and the common electrode substrate, which form a plurality of liquid crystal cells cut as described above, that is, a liquid crystal panel, and the thin film transistor substrate and the common electrode substrate are sealed so that the injected liquid crystal molecules do not leak (S250). A vacuum injection method using a pressure difference created by making the gap between two substrates vacuous may be used for injecting the liquid crystal molecules into the gap.

Polarizers may be attached on both upper and lower surfaces of the liquid crystal panel into which the liquid crystal molecules are injected (S260). The desirable liquid crystal panels may be selected by an electrical and optical performance test and a process of attaching polarizers S260 may then be performed.

As described above, after the liquid crystal cell process S20 is performed on the liquid crystal panels, a module process S30 is performed on the liquid crystal panels. The module process S30 may include a process of mounting a driving IC, a process of attaching a printed circuit board (PCB), and a process of assembling a backlight unit and sash.

The liquid crystal display formed by the module process S30 may include a liquid crystal panel, a backlight unit, a sash, and a driving IC unit. The liquid crystal display may be released after a shipment inspection, such as an aging test, is completed.

Hereinafter, a three-scan process of printing an alignment layer of the above-mentioned processes of printing an alignment layer will be described in detail with reference to FIG. 5, FIG. 6A, FIG. 6B, and FIG. 6C.

FIG. 5 schematically shows a three-scan process of printing an alignment layer that is an example of the process of printing an alignment layer shown in FIG. 2, and FIG. 6A, FIG. 6B, and FIG. 6C are views showing the process of printing an alignment layer shown in FIG. 5.

First, as described above with reference to FIG. 3 and FIG. 4, the alignment layer printing apparatus 100 places and fixes the mother substrate 10 on the stage 20, and aligns the inkjet head 30 provided with the plurality of nozzles 31 with the mother substrate 10. Further, the control unit 40 supplies signals to control the motion of the plurality of inkjet heads 30 and stage 20.

Referring to FIG. 3, FIG. 5, and FIG. 6A, the above-mentioned alignment layer printing apparatus 100 performs a first printing for an alignment layer on the mother substrate 10 (S311). Specifically, when the inkjet head 30 is aligned over the upper surface of the mother substrate 10, alignment liquid 50 may be ejected from the plurality of nozzles 31 and 32 onto the upper surface of the mother substrate 10 so that an alignment layer is printed on the upper surface thereof. In this case, the control unit 40 moves the stage 20 in the first direction of the mother substrate 10, for example, in the Y-direction. Further, the control unit 40 supplies control signals to the plurality of nozzles 31 and 32 so that alignment liquid 50 may be ejected from the plurality of nozzles 31 and 32. The distance d₁₀ between the rows of alignment liquid 51 and 51′ disposed on the mother substrate 10 during the first printing may be substantially equal to the distance D between adjacent nozzles 31 and 32.

Next, referring to FIG. 2, FIG. 3, FIG. 5, and FIG. 6B, the inkjet head 30 may be moved in the second direction (S312), and a second printing for an alignment layer may then be performed on the mother substrate 10 (S313). Specifically, the inkjet head 30 may be moved a predetermined distance in the second direction of the mother substrate 10, for example, in the X-direction, in accordance with the signals supplied from the control unit 40. Subsequently, the control unit 40 moves the stage 20 in the direction opposite to the first direction of the mother substrate 10, for example, in the direction opposite to the Y-direction, and supplies control signals to the nozzle 31, causing alignment liquid 50 to be ejected from the nozzle 31. In this case, the alignment liquid 52 of the second printing performed on the mother substrate 10 may be printed between the rows of alignment liquid 51 and 51′ disposed on the mother substrate 10 during the first printing. In other words, the inkjet head 30 may move from the position at which the alignment liquid 51 of the first printing was ejected in the second direction by a distance d₁₁ that may be ⅔ the distance between the rows of alignment liquid 51 and 51′ of the first printing. That is, the nozzle 31 may move in the second direction to a position located at a distance from the position of the nozzle 31 during the first printing that is substantially equal to ⅔ the distance D between the nozzles 31 and 32. Accordingly, the alignment liquid 52 of the second printing performed on the mother substrate 10 by the nozzle 31 of the moved inkjet head 30 may be printed between the rows of alignment liquid 51 and 51′ disposed during the first printing process shown in FIG. 6A.

Subsequently, referring to FIG. 2, FIG. 3, FIG. 5, and FIG. 6C, the inkjet head 30 may be moved in a direction opposite to the second direction (S314), and a third printing for an alignment layer may be performed on the mother substrate 10 (S315). Specifically, the inkjet head 30 may be moved a predetermined distance in the direction opposite to the second direction of the mother substrate 10, for example, in the direction opposite to the X-direction, in accordance with the signals supplied from the control unit 40. Subsequently, the control unit 40 moves the stage 20 in the first direction of the mother substrate 10, for example, in the Y-direction, and supplies control signals to the nozzle 31, causing alignment liquid 50 to be ejected from the nozzle 31. Alignment liquid 53 of the third printing performed on the mother substrate 10 may be printed between the rows of alignment liquid 51 and 52 of the first and second printings previously performed on the mother substrate 10. In other words, the inkjet head 30 may move from the position at which the alignment liquid 52 of the second printing was ejected in the direction opposite to the second direction by a distance d₁₂ that may be ⅓ the distance between the rows of alignment liquid 51 and 51′ printed during the first printing. That is, the nozzle 31 may move in the direction opposite to the second direction to a position located at a distance from the position of the nozzle 31 during the first printing that is substantially equal to ⅓ the distance D between the nozzles 31 and 32. Accordingly, the alignment liquid 53 of the third printing performed on the mother substrate 10 by the nozzle 31 of the moving inkjet head 30 may be printed between the rows of alignment liquid 51 and 52 of the first and second printings performed in the processes shown in FIG. 6A and FIG. 6B.

The three-scan process of printing an alignment layer, in which the inkjet head is reciprocated once in the second direction and prints an alignment layer, has been described above. According to the three-scan process of printing an alignment layer, the inkjet head is reciprocated in the second direction and prints the alignment layer on the mother substrate 10. Accordingly, it may be possible to form an alignment layer having a constant thickness on the mother substrate 10 thereby preventing the occurrence of linear stains. Further, according to the alignment layer printing apparatus of this exemplary embodiment, the stage is reciprocated in the first direction and the inkjet head is reciprocated in the second direction. However, the present invention is not limited thereto.

Hereinafter, a four-scan process of printing an alignment layer of the above-mentioned processes of printing an alignment layer will be described in detail with reference to FIG. 7, FIG. 8A, FIG. 8B, FIG. 8C, and FIG. 8D.

FIG. 7 shows a four-scan process of printing an alignment layer that is an example of the process of printing an alignment layer shown in FIG. 2, and FIG. 8A, FIG. 8B, FIG. 8C, and FIG. 8D are views showing the process of printing an alignment layer shown in FIG. 7.

First, as described above with reference to FIG. 3 and FIG. 4, the alignment layer printing apparatus 100 places and fixes the mother substrate 10 on the stage 20, and aligns the inkjet head 30 provided with the plurality of nozzles 31 with the mother substrate 10. Further, the control unit 40 supplies signals to control the motion of the plurality of inkjet heads 30 and stage 20.

Referring to FIG. 2, FIG. 3, FIG. 7, and FIG. 8A, the above-mentioned alignment layer printing apparatus 100 performs a first printing for an alignment layer on the mother substrate 10 (S321). Specifically, when the inkjet head 30 is aligned over the upper surface of the mother substrate 10, alignment liquid 50 may be ejected from the plurality of nozzles 31 and 32 onto the upper surface of the mother substrate 10 so that an alignment layer is printed on the upper surface thereof. In this case, the control unit 40 moves the stage 20 in the first direction of the mother substrate 10, for example, in the Y-direction. Further, the control unit 40 supplies control signals to the plurality of nozzles 31 and 32 causing alignment liquid 50 to be ejected from the plurality of nozzles 31 and 32. The distance d₁₀ between rows of alignment liquid 51 and 51′ disposed during the first printing performed on the mother substrate 10 may be substantially equal to the distance D between adjacent nozzles 31 and 32.

Next, referring to FIG. 2, FIG. 3, FIG. 7, and FIG. 8B, the inkjet head 30 may be moved in the second direction (S322), and second printing for an alignment layer may then be performed on the mother substrate 10 (S323). Specifically, the inkjet head 30 may be moved a predetermined distance in the second direction of the mother substrate 10, for example, in the X-direction, in accordance with the signals supplied from the control unit 40. Subsequently, the control unit 40 moves the stage 20 in the direction opposite to the first direction of the mother substrate 10, for example, in the direction opposite to the Y-direction, and supplies control signals to the nozzle 31, causing alignment liquid 50 to be ejected from the nozzle 31. In this case, the alignment liquid 52 of the second printing performed on the mother substrate 10 may be printed between the rows of alignment liquid 51 and 51′ disposed on the mother substrate 10 during the first printing. In other words, the inkjet head 30 may move from the position at which the alignment liquid 51 of the first printing was ejected in the second direction by a distance d₁₃ that may be ½ the distance between the rows of alignment liquid 51 and 51′. That is, the nozzle 31 may move in the second direction to a position located at a distance from the position of the nozzle 31 during the first printing that is substantially equal to ½ the distance D between the nozzles 31 and 32. Accordingly, the alignment liquid 52 of the second printing performed on the mother substrate 10 by the nozzle 31 of the moved inkjet head 30 may be printed between the rows of alignment liquid 51 and 51′ of the first printing performed in the process shown in FIG. 8A.

Subsequently, referring to FIG. 2, FIG. 3, FIG. 7, and FIG. 8C, the inkjet head 30 may be moved in the direction opposite to the second direction (S324), and a third printing for an alignment layer may be performed on the mother substrate 10 (S325). Specifically, the inkjet head 30 may be moved a predetermined distance in the direction opposite to the second direction of the mother substrate 10, for example, in the direction opposite to the X-direction, in accordance with the signals supplied from the control unit 40. Subsequently, the control unit 40 moves the stage 20 in the first direction of the mother substrate 10, for example, in the Y-direction, and supplies control signals to the nozzle 31, causing alignment liquid 50 to be ejected from the nozzle 31. Alignment liquid 53 of the third printing performed on the mother substrate 10 may be printed between the rows of alignment liquid 51 and 52 of the first and second printings performed on the mother substrate 10. In other words, the inkjet head 30 may move from the position at which the alignment liquid 52 of the second printing was ejected in the direction opposite to the second direction by a distance d₁₄ that may be ¼ the distance between the rows of alignment liquid 51 and 51′. That is, nozzle 31 may move in the direction opposite to the second direction to a position located at a distance from the position of the nozzle 31 during the first printing that is substantially equal to ¼ the distance D between the nozzles 31 and 32. Accordingly, the alignment liquid 53 of the third printing performed on the mother substrate 10 by the nozzle 31 of the moved inkjet head 30 may be printed between the rows of alignment liquid 51 and 52 of the first and second printings performed in the processes shown in FIG. 8A and FIG. 8B.

Next, referring to FIG. 2, FIG. 3, FIG. 7, and FIG. 8D, the inkjet head 30 may be moved in the second direction (S326), and a fourth printing for an alignment layer may be performed on the mother substrate 10 (S327). Specifically, the inkjet head 30 may be moved a predetermined distance in the second direction of the mother substrate 10, for example, in the X-direction in accordance with the signals supplied from the control unit 40. Subsequently, the control unit 40 moves the stage 20 in the direction opposite to the first direction of the mother substrate 10, for example, in the direction opposite to the Y-direction, and supplies control signals to the nozzle 31, causing alignment liquid 50 to be ejected from the nozzle 31. Alignment liquid 54 of the fourth printing performed on the mother substrate 10 may be printed between the rows of alignment liquid 51′ and 52 of the first and second printings performed on the mother substrate 10. In other words, the inkjet head 30 may move from the position at which the alignment liquid 53 of the third printing was ejected in the second direction by a distance d₁₅ that may be ½ the distance between the rows of alignment liquid 51 and 51′. That is, the nozzle 31 may move in the second direction to a position located a distance of ¾ the distance D between the nozzles 31 and 32 from the position of the nozzle 31 during the first printing. Accordingly, the alignment liquid 54 of the fourth printing performed on the mother substrate 10 by the nozzle 31 of the moved inkjet head 30 may be printed between the rows of alignment liquid 51′ and 52 of the first and second printings performed in the processes shown in FIG. 8A and FIG. 8B.

The four-scan process of printing an alignment layer, in which the inkjet head is reciprocated twice in the second direction and prints an alignment layer has been described above. According to the four-scan process of printing an alignment layer, the inkjet head is reciprocated in the second direction and prints the alignment layer on the mother substrate 10. Accordingly, it may be possible to form an alignment layer having a constant thickness on the mother substrate 10, thereby preventing the occurrence of linear stains. Furthermore, according to the alignment layer printing apparatus in this exemplary embodiment, the stage is reciprocated in the first direction and the inkjet head is reciprocated in the second direction. However, the present invention is not limited thereto.

Hereinafter, a six-scan process of printing an alignment layer of the above-mentioned processes of printing an alignment layer will be described in detail with reference to FIG. 9, FIG. 10A, FIG. 10B, FIG. 10C, FIG. 10D, FIG. 10E, and FIG. 10F.

FIG. 9 schematically shows a six-scan process of printing an alignment layer that is an example of the process of printing an alignment layer shown in FIG. 2, and FIG. 10A, FIG. 10B, FIG. 10C, FIG. 10D, FIG. 10E, and FIG. 10F are views showing the process of printing an alignment layer shown in FIG. 9.

First, as described above with reference to FIG. 3 and FIG. 4, the alignment layer printing apparatus 100 places and fixes the mother substrate 10 on the stage 20, and aligns the inkjet head 30 provided with the plurality of nozzles 31 with the mother substrate 10. Further, the control unit 40 supplies signals to control the motion of the plurality of inkjet heads 30 and stage 20.

Referring to FIG. 2, FIG. 3, FIG. 9, and FIG. 10A, the above-mentioned alignment layer printing apparatus 100 performs a first printing for an alignment layer on the mother substrate 10 (S331). Specifically, when the inkjet head 30 is aligned over the upper surface of the mother substrate 10, alignment liquid 50 may be ejected from the plurality of nozzles 31 and 32 onto the upper surface of the mother substrate 10 so that an alignment layer is printed on the upper surface thereof. In this case, the control unit 40 moves the stage 20 in the first direction of the mother substrate 10, for example, in the Y-direction. Further, the control unit 40 supplies control signals to the plurality of nozzles 31 and 32 causing alignment liquid 50 to be ejected from the plurality of nozzles 31 and 32. The distance d₁₀ between the rows of alignment liquid 51 and 51′ of the first printing performed on the mother substrate 10 may be substantially equal to a distance D between adjacent nozzles 31 and 32.

Next, referring to FIG. 2, FIG. 3, FIG. 9, and FIG. 10B, the inkjet head 30 may be moved in the second direction (S332), and second printing for an alignment layer may then be performed on the mother substrate 10 (S333). Specifically, the inkjet head 30 may be moved a predetermined distance in the second direction of the mother substrate 10, for example, in the X-direction, in accordance with the signals supplied from the control unit 40. Subsequently, the control unit 40 moves the stage 20 in the direction opposite to the first direction of the mother substrate 10, for example, in the direction opposite to the Y-direction, and supplies control signals to the nozzle 31, causing alignment liquid 50 to be ejected from the nozzle 31. The alignment liquid 55 of the second printing performed on the mother substrate 10 may be printed between the rows of alignment liquid 51 and 51′ disposed on the mother substrate 10 during the first printing. In other words, the inkjet head 30 may move from the position at which the alignment liquid 51 of the first printing was ejected in the second direction by a distance d₁₆ that may be ½ the distance between the rows of alignment liquid 51 and 51′. That is, the nozzle 31 may move in the second direction to a position located at a distance from the position of the nozzle 31 during the first printing that is substantially equal to ½ the distance D between the nozzles 31 and 32. Accordingly, the alignment liquid 55 of the second printing performed on the mother substrate 10 by the nozzle 31 of the moved inkjet head 30 may be printed between the rows of alignment liquid 51 and 51′ disposed during the first printing performed in the process shown in FIG. 10A.

Subsequently, referring to FIG. 2, FIG. 3, FIG. 9, and FIG. 10C, the inkjet head 30 may be moved in the direction opposite to the second direction (S334), and third printing for an alignment layer may be performed on the mother substrate 10 (S335). Specifically, the inkjet head 30 may be moved a predetermined distance in the direction opposite to the second direction of the mother substrate 10, for example, in the direction opposite to the X-direction, in accordance with the signals supplied from the control unit 40. Subsequently, the control unit 40 moves the stage 20 in the first direction of the mother substrate 10, for example, in the Y-direction, and supplies control signals to the nozzle 31, causing alignment liquid 50 to be ejected from the nozzle 31. Alignment liquid 56 of the third printing performed on the mother substrate 10 may be printed between the rows of alignment liquid 51 and 55 of the first and second printings performed on the mother substrate 10. Specifically, the inkjet head 30 may move from the position at which the alignment liquid 55 of the second printing was ejected in the direction opposite to the second direction by a distance d₁₇ that may be ⅓ the distance between the rows of alignment liquid 51 and 51′ so as to be adjacent to the alignment liquid 51 disposed during the first printing. That is, the nozzle 31 may move in the direction opposite to the second direction to a position located at a distance from the position of the nozzle 31 during the first printing that is substantially equal to ⅙ the distance D between the nozzles 31 and 32, so as to be adjacent to the alignment liquid 51 disposed during the first printing. Accordingly, the alignment liquid 56 of the third printing performed on the mother substrate 10 by the nozzle 31 of the moved inkjet head 30 may be printed between the rows of alignment liquid 51 and 55 of the first and second printings performed in the processes shown in FIG. 10A and FIG. 10B.

Next, referring to FIG. 2, FIG. 3, FIG. 9, and FIG. 10D, the inkjet head 30 may moved in the second direction (S336), and fourth printing for an alignment layer may be performed on the mother substrate 10 (S337). Specifically, the inkjet head 30 may be moved a predetermined distance in the second direction of the mother substrate 10, for example, in the X-direction, in accordance with the signals supplied from the control unit 40. Subsequently, the control unit 40 moves the stage 20 in the direction opposite to the first direction of the mother substrate 10, for example, in the direction opposite to the Y-direction, and supplies control signals to the nozzle 31, causing alignment liquid 50 to be ejected from the nozzle 31. Alignment liquid 57 of the fourth printing performed on the mother substrate 10 may be printed between the rows of alignment liquid 51′ and 55 of the first and second printings performed on the mother substrate 10. Specifically, the inkjet head 30 may move from the position at which the alignment liquid 56 of the third printing was ejected in the second direction by a distance d₁₈ that may be ½ the distance between the rows of alignment liquid 51 and 51′ so as to be adjacent to the alignment liquid 55 disposed during the second printing. That is, the nozzle 31 may move in the second direction to a position located at a distance from the position of the nozzle 31 during the first printing that is substantially equal to ⅔ the distance D between the nozzles 31 and 32, so as to be adjacent to the alignment liquid 55 disposed during the second printing. Accordingly, the alignment liquid 57 of the fourth printing performed on the mother substrate 10 by the nozzle 31 of the moved inkjet head 30 may be printed between the rows of alignment liquid 51′ and 55 of the first and second printings performed in the processes shown in FIG. 10A and FIG. 10B.

Subsequently, referring to FIG. 2, FIG. 3, FIG. 9, and FIG. 10E, the inkjet head 30 may be moved in the direction opposite to the second direction (S338), and a fifth printing for an alignment layer may be performed on the mother substrate 10 (S339). Specifically, the inkjet head 30 may be moved a predetermined distance in the direction opposite to the second direction of the mother substrate 10, for example, in the direction opposite to the X-direction, in accordance with the signals supplied from the control unit 40. Subsequently, the control unit 40 moves the stage 20 in the first direction of the mother substrate 10, for example, in the Y-direction, and supplies control signals to the nozzle 31, causing alignment liquid 50 to be ejected from the nozzle 31. Alignment liquid 58 of the fifth printing performed on the mother substrate 10 may be printed between the rows of alignment liquid 55 and 56 of the second and third printings performed on the mother substrate 10. Specifically, the inkjet head 30 may move from the position at which the alignment liquid 57 of the fourth printing was ejected in the direction opposite to the second direction by a distance d₁₉ that may be ⅓ the distance between the rows of alignment liquid 51 and 51′. That is, the nozzle 31 may move in the direction opposite to the second direction to a position located at a distance from the position of the nozzle during the first printing that is substantially equal to ⅓ the distance D between the nozzles 31 and 32. Accordingly, the alignment liquid 58 of the fifth printing performed on the mother substrate 10 by the nozzle 31 of the moved inkjet head 30 may be printed between the rows of alignment liquid 55 and 56 of the second and third printings performed in the processes shown in FIG. 10B and FIG. 10C.

Next, referring to FIG. 2, FIG. 3, FIG. 9, and FIG. 10F, the inkjet head 30 may be moved in the second direction (S340), and a sixth printing for an alignment layer may be performed on the mother substrate 10 (S341). Specifically, the inkjet head 30 may be moved a predetermined distance in the second direction of the mother substrate 10, for example, in the X-direction, in accordance with the signals supplied from the control unit 40. Subsequently, the control unit 40 moves the stage 20 in the direction opposite to the first direction of the mother substrate 10, for example, in the direction opposite to the Y-direction, and supplies control signals to the nozzle 31, causing alignment liquid 50 to be ejected from the nozzle 31. Alignment liquid 59 of the sixth printing performed on the mother substrate 10 may be printed between the rows of alignment liquid 51′ and 57 of the first and fourth printings performed on the mother substrate 10. Specifically, the inkjet head 30 may move from the position at which the alignment liquid 58 of the fifth printing was ejected in the second direction by a distance d₂₀ that may be ½ the distance between the rows of alignment liquid 51 and 51′. That is, the nozzle 31 may move in the second direction to a position located at a distance from the position of the nozzle 31 during the first printing that is substantially equal to ⅚ the distance D between the nozzles 31 and 32. Accordingly, the alignment liquid 59 of the sixth printing performed on the mother substrate 10 by the nozzle 31 of the moved inkjet head 30 may be printed between the rows of alignment liquid 51′ and 57 of the first and fourth printings performed in the processes shown in FIG. 10A and FIG. 10D.

The six-scan process of printing an alignment layer, in which the inkjet head is reciprocated three times in the second direction and prints an alignment layer, has been described above. According to the six-scan process of printing an alignment layer, the inkjet head is reciprocated in the second direction and prints the alignment layer on the mother substrate. Accordingly, it may be possible to form an alignment layer having a constant thickness on the mother substrate, thereby preventing the occurrence of linear stains. Furthermore, according to the alignment layer printing apparatus in this exemplary embodiment, the stage is reciprocated in the first direction and the inkjet head is reciprocated in the second direction. However, the present invention is not limited thereto.

Further, the three-scan, four-scan, and six-scan processes of printing an alignment layer have been described in these exemplary embodiments. However, the present invention is not limited thereto, and it is apparent that the present invention can be applied to a process of printing an alignment layer including at least one returning course of an inkjet head, that is, at least one reciprocating course of an inkjet head.

As described above, according to a process of printing an alignment layer of a liquid crystal display of the present invention, while a stage and inkjet head are reciprocated, the inkjet head prints an alignment layer. For this reason, it may be possible to form an alignment layer having a constant thickness. As a result, it may be possible to prevent the occurrence of linear stains.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A process of printing an alignment layer of a liquid crystal display, the process comprising:
disposing a substrate on a stage;
aligning an inkjet head on the upper surface of the substrate, the inkjet head comprising a plurality of nozzles;
printing alignment liquid from the plurality of nozzles onto the upper surface of the substrate along a first direction; and
moving the inkjet head along a second direction,
wherein printing alignment liquid and moving the inkjet head are alternately performed and the stage or inkjet head is reciprocated at least once along the first direction and at least once along the second direction.

2. The process of claim 1, wherein printing of the alignment liquid comprises:
performing a first printing of alignment liquid on the upper surface of the substrate while the stage or inkjet head is moved in the first direction;
moving the inkjet head in a second direction;
performing the second printing of alignment liquid on the upper surface of the substrate while the stage or inkjet head is moved in a direction opposite to the first direction;
moving the inkjet head in a direction opposite to the second direction; and
performing a third printing of alignment liquid on the upper surface of the substrate while the stage or inkjet head is moved in the first direction.

3. The process of claim 2, wherein the first printing of alignment liquid is performed such that rows of alignment liquid are printed on the upper surface of the substrate at an interval substantially equal to the distance between adjacent nozzles.

4. The process of claim 2, wherein the second printing of alignment liquid is performed when each nozzle is positioned at a distance from its position during the first printing that is substantially equal to ⅔ of the distance between adjacent nozzles.

5. The process of claim 2, wherein the third printing of alignment liquid is performed after each nozzle is positioned at a distance from its position during the first printing that is substantially equal to ⅓ of the distance between adjacent nozzles.

6. The process of claim 2, further comprising:
moving the inkjet head in the second direction after the third printing of alignment liquid; and
performing a fourth printing of alignment liquid on the upper surface of the substrate while the stage or inkjet head is moved in the direction opposite to the first direction.

7. The process of claim 6, wherein the second printing of alignment liquid is performed after each nozzle is positioned at a distance from its position during the first printing that is substantially equal to ½ of the distance between adjacent nozzles.

8. The process of claim 6, wherein the third printing of alignment liquid is performed after each nozzle is positioned at a distance from its position during the first printing that is substantially equal to ¼ of the distance between adjacent nozzles.

9. The process of claim 6, wherein the fourth printing of alignment liquid is performed when each nozzle is positioned at a distance from its position during the first printing that is substantially equal to ¾ of the distance between adjacent nozzles.

10. The process of claim 6, further comprising:
moving the inkjet head in the direction opposite to the second direction after the fourth printing of alignment liquid;
performing a fifth printing of alignment liquid on the upper surface of the substrate while the stage or inkjet head is moved in the first direction;
moving the inkjet head in the second direction; and
performing a sixth printing of alignment liquid on the upper surface of the substrate while the stage or inkjet head is moved in the direction opposite to the first direction.

11. The process of claim 10, wherein the second printing of alignment liquid is performed after each nozzle is positioned at a distance from its position during the first printing that is substantially equal to ½ of the distance between adjacent nozzles.

12. The process of claim 10, wherein the third printing of alignment liquid is performed after each nozzle is positioned at a distance from its position during the first printing that is substantially equal to ⅙ of the distance between adjacent nozzles.

13. The process of claim 10, wherein the fourth printing of alignment liquid is performed after each nozzle is positioned at a distance from its position during the first printing that is substantially equal to ⅔ of the distance between adjacent nozzles.

14. The process of claim 10, wherein the fifth printing of alignment liquid is performed after each nozzle is positioned at a distance from its position during the first printing tha 12
